(19) United States
(12) Patent Application Publication
(10) Pub. No.: US 2008/0134553 A1
(43) Pub. Date: Jun. 12, 2008

(54) Vehicle provided with a clamping profile that is secured along a wall of the vehicle for fixing advertising material to the vehicle

(76) Inventor: Martijn Frits Zewald, Limmen (NL)

Correspondence Address: YOUNG & THOMPSON, 209 Madison Street, Suite 500, ALEXANDRIA, VA, 22314, US

(21) Appl. No.: 11/634,188

(22) Filed: Dec. 6, 2006

(51) Int. Cl. G09F 21/04

(52) U.S. Cl. 40/590

(57) ABSTRACT

A vehicle is provided with a clamping profile which is secured along a wall of the vehicle for clamping advertising material to the vehicle, wherein the clamping profile is provided with a flexible lip which connects under pre-tension to the wall of the vehicle. Advertising material in the form of a sheet can be secured and/or replaced quickly and easily on such a vehicle. The flexible lip of the clamping profile counteracts the unsightly accumulation of dirt, prevents the securing of the profile on the surface from being affected and the profile cannot be caught in the wind.

The invention relates to a vehicle provided with a clamping profile that is secured along a wall of the vehicle for fixing advertising material to the vehicle.

Such a device is disclosed in EP 1.170.716. This device of prior art has a multiplicity of pins which are fixed in relation to a surface and which are inserted through holes in the advertising material in the form of a sheet for securing that advertising material. Furthermore, the device of prior art has a securing profile that interacts with the pins and keeps the advertising material pressed against the surface. The securing profile may in this case be provided with an inclined surface which seals the outer edge of the clamping profile from rainwater and small objects and the like.

A disadvantage of the profile of prior art is that the sealing of the outer edge of the clamping profile is not effective, particularly where the clamping profile is secured to a slightly curved surface, such as in the case of the curved wall of a delivery van.

The object of the invention is to provide a device with a clamping profile for securing advertising material in the form of a sheet to a vehicle, which profile is effectively sealed when applied to a slightly curved surface to prevent the penetration of water, wind, dirt and the like between the profile and the surface. This counteracts the unsightly accumulation of dirt, prevents the securing of the profile to the surface from being affected and ensures that the profile cannot be caught in the wind.

This object is achieved in that the clamping profile is provided with a flexible lip which is connected under pre-tension to the wall of the vehicle. Such a flexible lip provides a good seal between the profile and the vehicle, so that a barrier is created against rain, splashing water, wind, travel wind, dirt and the like.

The device preferably also comprises a plate-shaped carrier, the clamping profiles being fitted along the edges of the carrier so that the device as a whole can be fitted to the vehicle. The carrier and the clamping profiles are preferably rather flexible so that they rest firmly along a slightly curved surface, such as the outer wall of a delivery van. The respective flexible lips of the clamping profiles extend beyond the carrier so that they tightly connected to the wall of the vehicle. For securing the plate-shaped carrier to the vehicle it maybe provided with fixing means, preferably in the form of a double-sided adhesive strip.

The plate-shaped carrier may also be provided with an imprint so that even when no advertising material is applied, an image is still visible.

The invention also relates to a clamping profile for clamping advertising material, comprising a basic part, a leg connected tightly to the basic part and a leg connected in an articulated fashion to the basic part, where the fixed leg has a fixing face and a clamping face, and where the hinged leg can be moved between an open position for inserting/removing the advertising material and a closed position for clamping the advertising material between the hinged leg and the fixed leg. According to the invention the basic part is provided with a flexible lip which extends beyond the fixing face of the basic part.

If the clamping profile is secured to a carrier, the flexible lip also extends beyond that carrier.

With such a clamping profile advertising material in the form of a sheet can be secured and/or replaced quickly and easily. This is highly advantageous, particularly in the case of vehicles which are used for transport, since these vehicles have to remain in operation as possible due to cost considerations.

The clamping profile may be manufactured at low cost from plastic by means of extrusion.

The basic part and the legs preferably consist of hard polyvinyl chloride (PVC). Furthermore, the articulated connection between the basic part and the hinged leg preferably consists of thermoplastic polyurethane (TPU), which material provides a strong, flexible connection. Moreover, the clamping face of the basic part is preferably provided with a strip of a somewhat stiff material, such as TPU, which makes it difficult to pull clamped advertising material out of the clamping profile. In addition, the flexible lip preferably consists of soft PVC, so that the lip is formed effectively on the surface and provides a good seal.

The clamping face of the clamping profile is preferably provided with a flange which forms a stop for the advertising material, so that the advertising material can easily be clamped in the desired position, thereby shortening the rime required to secure and/or replace it.

Furthermore, the outside of the hinged leg of the clamping profile is preferably convex so that in the closed position an aerodynamic profile is obtained which disturbs the air flow along the travelling vehicle to a relatively small degree. This has a favourable effect on fuel consumption. Moreover, a clamping mechanism in such a form is less vulnerable to wind, thus preventing the clamping connection from loosening due to the wind.

Furthermore, the fixing face of the basic part of the clamping profile is preferably provided with an adhesive means such as an adhesive strip, so that the clamping profile can easily be fitted on the plate-shaped carrier, or directly onto the surface of the vehicle.

The invention will be explained with reference to an exemplary embodiment which is shown in the following figures.

FIG. 1 shows a perspective view of a vehicle provided with a clamping profile according to the invention.

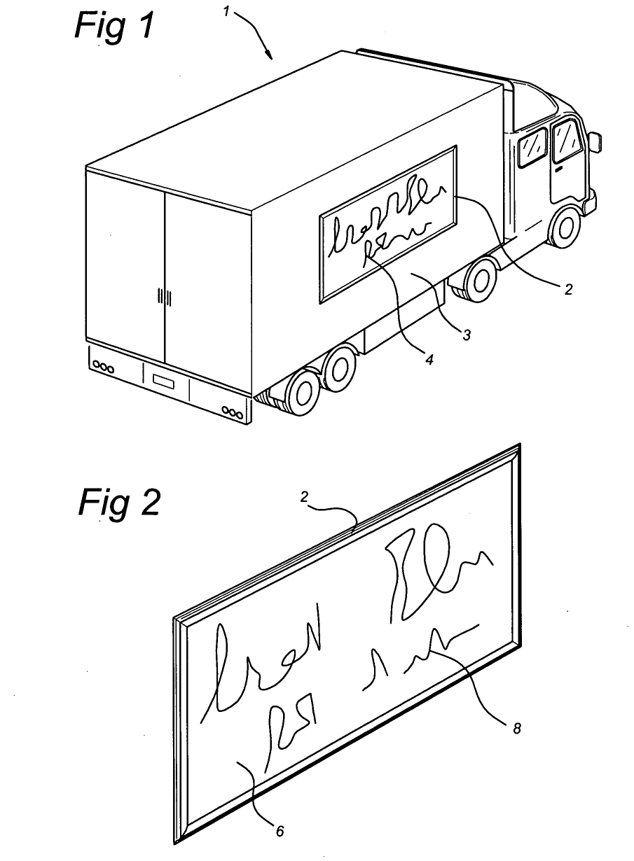

FIG. 2 shows a plate-shaped carrier with clamping profiles for applying to a vehicle according to the invention.

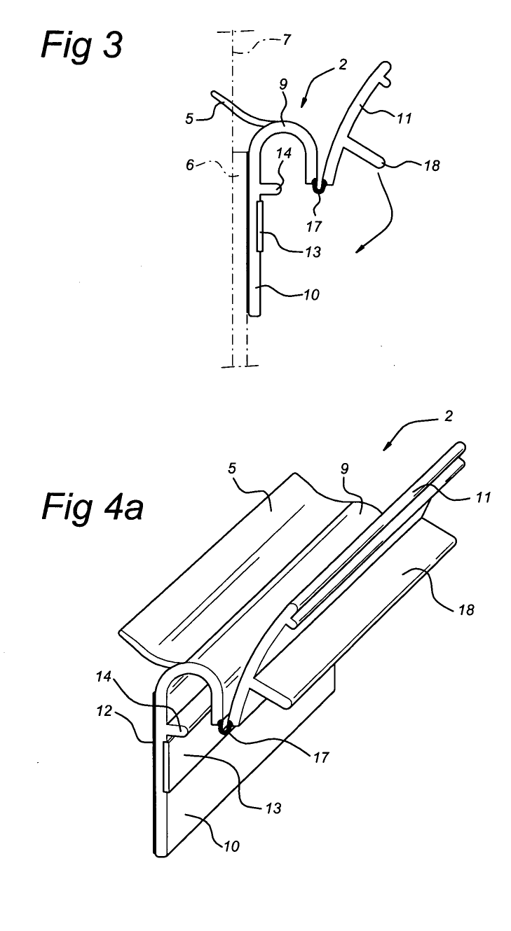

FIG. 3 shows, in section, a clamping profile according to the invention that is secured to a plate-shaped carrier.

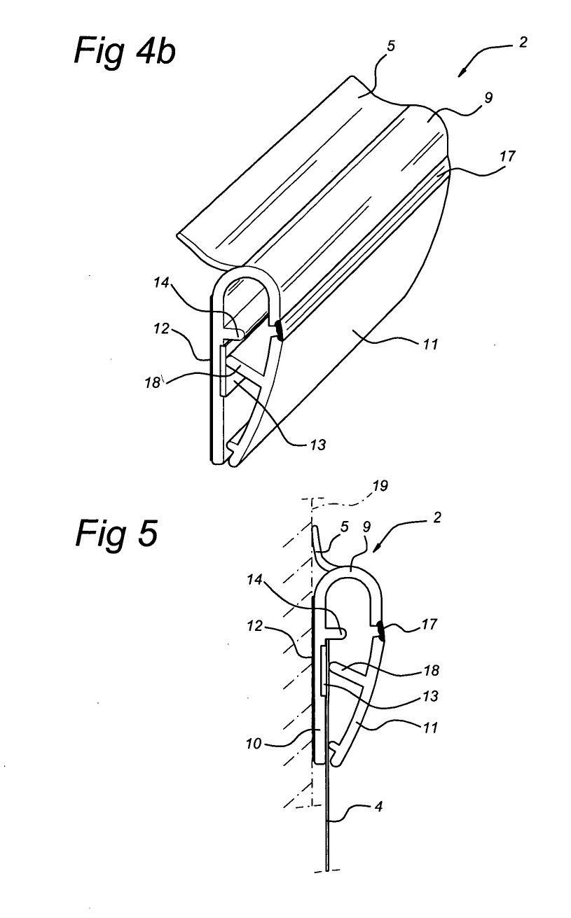

FIGS. 4a, 4b show a clamping profile according to the invention in the open and closed positions respectively.

FIG. 5 shows, in section, a clamping profile according to the invention, with advertising material clamped in it.

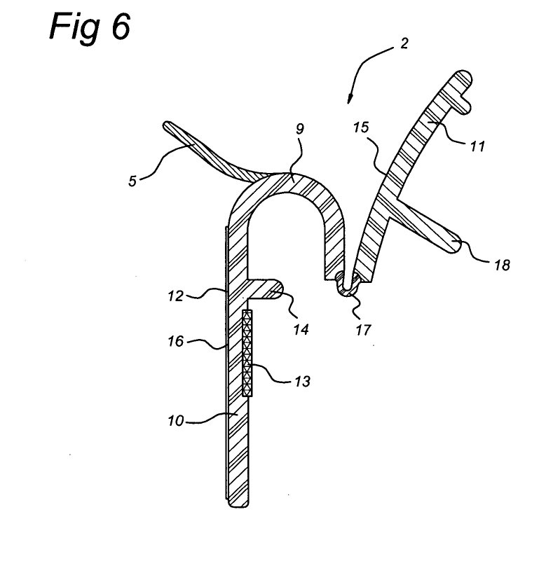

FIG. 6 shows, in section, the open clamping profile.

FIG. 1 shows a van 1 whose lateral wall 3 is provided with advertising material 4, which takes the form of a rectangular poster of laminated cardboard or printed plasticised cloth. Such a poster normally has a thickness of approximately 0.3 mm. The advertising material is secured to wall 3 of the vehicle, so that it can be removed, by means of clamping profiles 2, which run along the edges of the poster. Clamping profiles 2 may be fixed directly onto wall 3 of vehicle 1 by means of double-sided adhesive strip, for example.

Clamping profiles 2 may also be fitted to a plate-shaped carrier 6, see FIG. 2, so that an easily handled unit is provided which can be fitted to the vehicle. Furthermore, carrier 6 may be provided with an imprint 8, so that even if no advertising material is fitted, a standard image is still visible on the vehicle. The clamping profiles are provided with a flexible lip 5, which projects from carrier 6 and which is connected to the wall of the vehicle by pre-tension.

FIG. 3 shows, in section, such a clamping profile secured to carrier 6. As can be seen, the clamping profile is provided with a flexible lip which projects such a distance that it will lie flush against the wall of the vehicle under pre-tension.

FIGS. 4a and 4b show, for the sake of clarity, a perspective view of the clamping profile in the open and closed positions.

FIG. 5 shows a poster 4 clamped in clamping profile 2. This clamping is provided in that rib 18 of leg 11 is pressed against clamping face 13.

Finally, FIG. 6 shows clamping profile 2 in detail. The clamping profile consists principally of hard PVC and has a basic part 9, which is U-shaped. A flexible clamping is provided by designing basic part 9 in a U-shape. The clamping profile is sufficiently flexible to be fitted to a slightly curved surface.

A leg 10 of clamping profile 2 is fixed on U-shaped basic part 9 and has on one side a fixing face 12 for securing the profile to a surface, for example by means of double-sided adhesive strip 16. On the other side of leg 10 there is a clamping face 13 for clamping the advertising material in interaction with the other leg 11, in particular rib 18 formed on it. Clamping face 13 is provided with a stiff section, of TPU for example, so that a poster clamped in the profile is prevented from tearing loose.

The other leg 11 is hinged relative to basic part 9 and because of this is connected by a flexible connection 17 consisting of TPU. Leg 11 can be moved in a closed position, where material in the form of a sheet is clamped between rib 18, which is located on leg 11, and the stiff section of clamping face 13 of leg 10.

The clamping face is provided with a flange 14 which acts as a stop for material in sheet form. This simplifies the fitting and positioning of advertising material on the vehicle.

Flexible lip 5 is provided on basic part 9, in the location of the closed side of U-shaped basic part 9. If the profile is not secured to a surface 19, lip 5 extends beyond fixing face 12 of the clamping profile (see FIGS. 4a, 4b), so that it lies flush against that surface under pre-tension when the profile is secured to a surface (see FIG. 5).

If the profile is fitted to a plate-shaped carrier 6, lip 5 extends beyond face 7 of carrier 6 located on the side of the vehicle, see FIG. 3.

The entire profile, with the different materials in it, can be manufactured in one operation by extrusion.

1. A vehicle (1), provided with a clamping profile (2) which is secured along a wall (3) of the vehicle for the clamping of advertising material (4) to that wall (3), characterised in that the clamping profile (2) is provided with a flexible lip (5) which is connected under pre-tension to the wall (3) of the vehicle.

2. The vehicle (1) according to claim 2, wherein a plate-shaped carrier (6) is provided and the clamping profile (2) is secured to an edge of that plate-shaped carrier (6).

3. The vehicle (1) according to claim 1, wherein four clamping profiles (2) are fixed relative to the wall (3) of the vehicle, which clamping profiles (2) form the respective sides of a rectangle, and wherein the size of that rectangle corresponds mainly to the size of the advertising material (4).

4. The vehicle according to claim 2, wherein the plate-shaped carrier (6) is provided with an impression (8) on the side facing away from the vehicle.

5. A clamping profile (2) for clamping advertising material (4) for application to a vehicle (1) according to claim 1, comprising a basic part (9), a leg (10) tightly connected to the basic part (9) and a hinged leg (11) connected to the basic part, wherein the fixed leg (10) has a securing face (12) for securing the clamping profile to a surface (1, 3, 6), and wherein the hinged leg (11) can be moved between an open position for inserting/removing the advertising material (4) and a closed position for clamping the advertising material (4) between the hinged leg (11) and the fixed leg (10), characterised in that the basic part (9) is provided with a flexible lip (5) which extends beyond the securing face (12) of the basic part (9).

6. The clamping profile (2) according to claim 5, wherein the basic part (9) is U-shaped.

7. The clamping profile (2) according to claim 5, wherein the fixed leg (10) has a clamping face (13) which comprises a stiff material.

8. The clamping profile (2) according to claim 5, wherein the clamping face (13) is provided with a flange (14) which forms a stop for the advertising material (4).

9. The clamping profile (2) according to claim 5, wherein the outside (15) of the hinged leg (11) is convex.

10. The clamping profile (2) according to claim 5, wherein the securing face (12) of the basic part (9) is provided with an adhesive means (16).

11. The clamping profile (2) according to claim 5, wherein the clamping profile (2) is an integral element of plastic that is formed by extrusion.

12. The clamping profile (2) according to claim 11, wherein the basic part (9) and the legs (10, 11), comprise hard PVC, wherein the basic part (9) and the hinged leg (1) are connected in an articulated fashion by a flexible connection (17) which consists of TPU, wherein the clamping face (13) of the basic part comprises TPU, and wherein the flexible lip (5) comprises soft PVC.

13. An assembly comprising a clamping profile (2) and a plate-shaped carrier (6), wherein the clamping profile (2) is secured to the plate-shaped carrier (6), and wherein the flexible lip (5) of the clamping profile (2) extends beyond the face of the plate-shaped carrier (6) facing away from the clamping profile (2).

14. The vehicle (1) according to claim 2, wherein four clamping profiles (2) are fixed relative to the wall (3) of the vehicle, which clamping profiles (2) form the respective sides of a rectangle, and wherein the size of that rectangle corresponds mainly to the size of the advertising material (4).

15. The vehicle according to claim 3, wherein the plate-shaped carrier (6) is provided with an impression (8) on the side facing away from the vehicle.

16. A clamping profile (2) for clamping advertising material (4) for application to a vehicle (1) according to claim 2, comprising a basic part (9), a leg (10) tightly connected to the basic part (9) and a hinged leg (11) connected to the basic part, wherein the fixed leg (10) has a securing face (12) for securing the clamping profile to a surface (1, 3, 6), and wherein the hinged leg (11) can be moved between an open position for inserting/removing the advertising material (4) and a closed position for clamping the advertising material (4) between the hinged leg (11) and the fixed leg (10), characterised in that the basic part (9) is provided with a flexible lip (5) which extends beyond the securing face (12) of the basic part (9).

17. A clamping profile (2) for clamping advertising material (4) for application to a vehicle (1) according to claim 2, comprising a basic part (9), a leg (10) tightly connected to the basic part (9) and a hinged leg (11) connected to the basic part, wherein the fixed leg (10) has a securing face (12) for securing the clamping profile to a surface (1, 3, 6), and wherein the hinged leg (11) can be moved between an open position for inserting/removing the advertising material (4) and a closed position for clamping the advertising material (4) between the hinged leg (11) and the fixed leg (10), characterised in that the basic part (9) is provided with a flexible lip (5) which extends beyond the securing face (12) of the basic part (9).

18. A clamping profile (2) for clamping advertising material (4) for application to a vehicle (1) according to claim 2, comprising a basic part (9), a leg (10) tightly connected to the basic part (9) and a hinged leg (11) connected to the basic part, wherein the fixed leg (10) has a securing face (12) for securing the clamping profile to a surface (1, 3, 6), and wherein the hinged leg (11) can be moved between an open position for inserting/removing the advertising material (4) and a closed position for clamping the advertising material (4) between the hinged leg (11) and the fixed leg (10), characterised in that the basic part (9) is provided with a flexible lip (5) which extends beyond the securing face (12) of the basic part (9).

19. The clamping profile (2) according to claim 6, wherein the fixed leg (10) has a clamping face (13) which comprises a stiff material.

20. The clamping profile (2) according to claim 6, wherein the clamping face (13) is provided with a flange (14) which forms a stop for the advertising material (4).
